(19) United States
(12) Patent Application Publication
(10) Pub. No.: US 2025/0130266 A1
(43) Pub. Date: Apr. 24, 2025

(54) METHOD FOR CALCULATING THE ELECTRIC FIELD INSIDE A DIELECTRIC MATERIAL LAYER OF A HIGH VOLTAGE ELECTRIC CABLE FOR DIRECT ELECTRIC CURRENT, AND SYSTEM THEREOF

(71) Applicants: Giuseppe RIZZO, Palermo (PA) (IT); Pietro ROMANO, Palermo (PA) (IT); Antonino IMBURGIA, Altavilla Milicia (PA) (IT); Guido ALA, Palermo (PA) (IT)

(72) Inventors: Giuseppe RIZZO, Palermo (PA) (IT); Pietro ROMANO, Palermo (PA) (IT); Antonino IMBURGIA, Altavilla Milicia (PA) (IT); Guido ALA, Palermo (PA) (IT)

(21) Appl. No.: 18/688,216

(22) PCT Filed: Sep. 2, 2022
(86) PCT No.: PCT/IT2022/050240

§ 371 Date: Feb. 29, 2024

(30) Foreign Application Priority Data
Sep. 3, 2021 (IT) 102021000022886

(51) Int. Cl. G01R 31/12; G01R 31/58; G06F 30/23; G06F 113/16; G06F 119/08

(52) U.S. Cl. CPC G01R 31/1272; G01R 31/58; G06F 30/23; G06F 2113/16; G06F 2119/08

(57) ABSTRACT

A method for calculating the electric field inside a dielectric material layer of a high voltage electric cable for direct electric current is disclosed. The method is designed to numerically calculate an electric field distribution referred to the dielectric material layer, substantially in real time and by solving differential equations expressed in discrete form. A system for calculating the electric field inside a dielectric material layer of a high voltage electric cable for direct electric current is also disclosed.

The present invention relates to the sector of the transmission of electrical energy in direct electric current and in particular it concerns a method for calculating the electric field within a dielectric material layer of a high voltage electric cable for direct electric current.

More specifically, said method is designed to automatically and substantially calculate in real time the electric field distribution over time within a dielectric material layer included in the electric cable itself.

The present invention also relates to a system for calculating said electric field by means of said method.

### PRIOR ART

An electric cable is an electrical component that includes from the inside to the outside in succession:
a conductor made of metallic material,
at least a first layer of semiconductive material, arranged around the conductor,
a dielectric material layer, arranged around said first semiconductive material layer,
at least a second semiconductive material layer, arranged around said dielectric material layer,
at least one metallic material layer called screen.

Further layers may be present in the electrical cable depending on the type of application of the electrical cable.

In general, the main function of the dielectric material layer is to withstand the electrical stress to which it is subjected during the operation of the electrical cable, ensuring that the conductor and screen are electrically insulated from each other.

The thickness and type of dielectric material are selected and sized on the basis of the electrical stress and also the thermal and mechanical stress to be withstand, to prevent the properties of said dielectric material from being degraded.

Currently, a method is known to monitor in real time the maximum temperature inside the conductor and the maximum temperature on the external surface of a high voltage electric cable for direct electric current by measuring the electric current flowing in the conductor in the axial direction. (i.e. along the longitudinal axis of the electric cable) with the aim of preventing the temperature associated with the conductor from being greater than a predetermined temperature value or temperature threshold value.

Furthermore, this method allows the following values of electric current to be calculated in real time:
i) a first maximum value associated with an admissible permanent electric current which can flow continuously for an indefinite time in a conductor under the conditions of use without exceeding a temperature threshold under nominal conditions;
ii) at least a second value associated with an admissible permanent electric current which can flow continuously for a predetermined time in a conductor in the conditions of use without exceeding a further temperature threshold in emergency conditions.

This method is the same method used to monitor high voltage electrical cables for alternating current.

However, the use of a method designed to monitor high voltage electrical cables for alternating current in order to monitor high voltage electrical cables for direct current has some disadvantages.

A disadvantage is that a method designed to monitor high voltage electric cables for alternating current does not allow real time monitoring of the electric field inside the dielectric material layer of a high voltage electric cable for direct current.

Therefore, monitoring a high voltage electric cable for direct electric current using the same method with which a high voltage electric cable for alternating current is monitored does not allow to evaluate the risks deriving from the accumulation of spatial electric charge inside the dielectric material layer.

If on the one hand these phenomena are not relevant in a high voltage electric cable for alternating electric current, on the other hand, in a high voltage electric cable for direct electric current, said phenomena cause premature aging and a loss of dielectric properties of the dielectric material layer of the electric cable.

In fact, the electrical stress is conditioned not only by the voltage applied between the conductor and the screen, but also by accumulation phenomena of spatial electric charge that occur over time, when the electric cable is in use, in which said phenomena are related to the electric field variations over time.

Therefore, if the time-varying electric field is not monitored and consequently not known, it is not possible to evaluate the entity of said phenomena and the dielectric material layer of the electric cable can be subjected over time to the risks mentioned above (i.e. aging and loss of dielectric properties).

### Aim of the Invention

The aim of the present invention is to overcome said disadvantage by providing a method for calculating automatically and substantially in real time the electric field within a dielectric material layer of a high voltage electric cable for direct electric current.

Advantageously, by means of said method, the possibilities that said dielectric material layer is subject to premature aging and/or a loss of its dielectric properties and/or runs the risk of failure are limited.

A further object of the present invention is to provide a system for carrying out this method.

### OBJECT OF THE INVENTION

Object of the invention is a method for calculating the electric field within a dielectric material layer of a high voltage electric cable for direct electric current according to claim 1.

Further preferred embodiments are described in the method dependent claims.

A further object of the invention is a system for calculating the electric field within a dielectric material layer of a high voltage electric cable for direct electric current according to claim 15.

Further preferred embodiments are described in the system dependent claims.

### FIGURE LIST

The present invention will be now described, for illustrative, but not limitative purposes, according to its embodiment, making particular reference to the enclosed figures, wherein:

FIG. 1 is a schematic view of an electric cable comprising from inside to outside a conductor, a first semiconductive material layer, a dielectric material layer, a second semiconductive material layer and a metallic material layer called shield and an outer layer which is a sheath, in which a plurality of planes transverse to the longitudinal axis of the electric cable, temperature measuring means, an electric current measuring device, a voltage measuring device between said conductor and said shield, and a computer, connected to said temperature measuring means, to said electric current measuring device and to said voltage measuring device, are visible;

FIGS. 2A, 2B, 2C show a respective computing domain associated with a respective area that includes a respective section of the electric cable, in which said area is arranged on a respective transverse plane to the longitudinal axis of the electric cable;

FIGS. 3A, 3B, 3C show a respective further computing domain associated with a respective further area, in which said further area is arranged inside said electric cable, between the first semiconductive material layer and the second semiconductive material layer of the electric cable (in FIGS. 3A, 3B 3C, the conductor, the shield and the outer layer of the electric cable are not shown);

FIG. 4 is a schematic view of a grid of the computation domain of FIG. 2A comprising a plurality of finite elements to be used for the computation of a temperature distribution by means of a finite element method;

FIG. 5 shows an enlargement of a detail of FIG. 4 to show some finite elements of said computing domain, arranged along a radial direction of the electric cable;

FIG. 6 shows an enlargement of FIG. 5 of a detail of FIG. 4 to show some finite elements belonging to the further calculation domain, arranged along a radial direction of the electric cable, to be used for the calculation of an electric field distribution by means of a further finite element method.

### DETAILED DESCRIPTION OF THE INVENTION

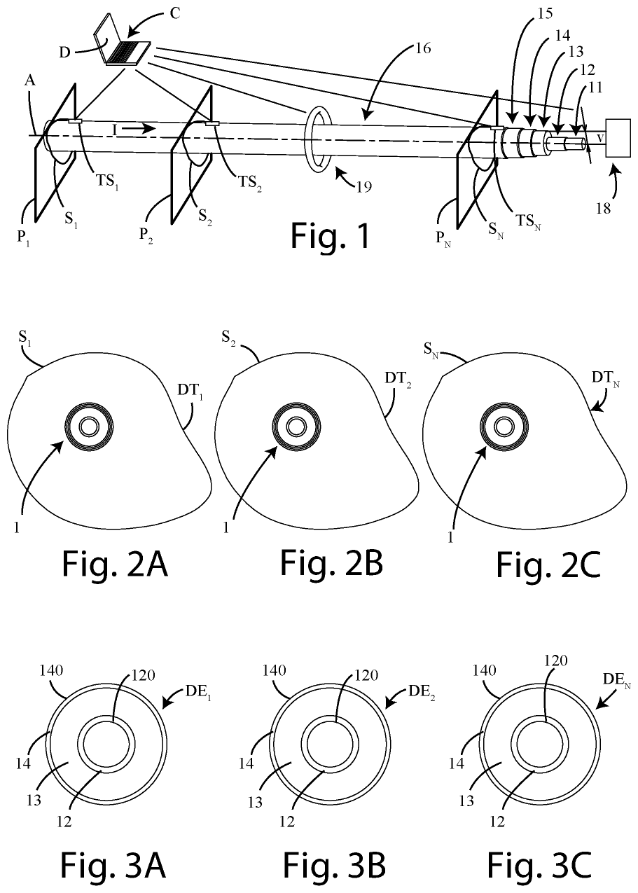

With particular reference to FIG. 1, a method for calculating an electric field inside a dielectric material layer 13 of a high voltage electric cable 1 for direct electric current.

In particular, said electric cable 1 comprises a plurality of layers and more particularly from the inside towards the outside:
a conductor 11 having a longitudinal axis A,
a first semiconductive material layer 12,
said dielectric material layer 13,
a second semiconductive material layer 14,
a metallic material layer 15 called shield,

Moreover, said electric cable 1 further comprises an outer layer 16 which is a sheath.

In general, additional layers may be present inside the electric cable 1 according to the type of application of the electric cable itself.

For example, the electric cable can comprise further first semiconductive material layers and/or further second semiconductive material layers and/or further external layers.

However, in the embodiment being described, said electric cable 1 is constituted by said conductor 11, by said first semiconductive material layer 12, by said dielectric material layer 13, by said second semiconductive material layer 14, by said metallic material layer 15 called screen and from said outer layer 16.

Said method comprises the following steps:
A) identifying one or more areas Sⱼ, with j=1, 2 . . . N where N is a positive integer, each of which is arranged along said electric cable 1, on a respective plane Pⱼ transverse to the longitudinal axis A of said electric cable 1 and has a geometric shape defined by a closed reference line;
B) associating a respective computational domain DT_{J} with each area Sⱼ, as well as associating a respective further computational domain DE_{J} with a further area which is a portion of said area Sⱼ and is arranged inside said electric cable 1, between said first semiconductive material layer 12 and said second semiconductive material layer 14, wherein said computational domain DT_{J} is discretized through a set of finite elements e_{J1}, e_{J2} . . . e_{JM}, wherein J indicates the area and M is a positive integer and said further computational domain DE_{J} is discretized through a further set of finite elements e_{JX}, e_{JY} . . . e_{JL}, wherein J indicates the area and X, Y and L are positive integers used to indicate any finite element, and wherein said further area is included between a first closed line 120 and a second closed line 140 and in transversal section said first closed line 120 is a first contact line between the conductor 11 and said first semiconductive material layer 12 and said second closed line 140 is a second contact line between said second semiconductive material layer 14 and said shield 15;
C) acquiring:
   a value of temperature TE_{J} at each area Sⱼ through temperature measuring means TS_{J};
   a value of voltage V between said conductor 11 and said shield 15, wherein said value of voltage V is obtained through a voltage measuring device 18 or is a predetermined value of voltage;
   a value of electric current I flowing along the longitudinal axis A of the conductor 11, wherein said value of electric current I is obtained through an electric current measuring device 19 or is a predetermined value of electric current;
D) calculating, by means of a numerical finite element method, a respective temperature distribution Te_{J1}, Te_{J2} . . . Te_{JM} for each computational domain DT_{J}, wherein each value of temperature of a temperature distribution is associated with a respective finite element e_{J1}, e_{J2} . . . e_{JM} of a respective computational domain DT_{J}, each temperature distribution being calculated by solving:
   Fourier's law for conducting heat in transient conditions, starting from said temperature values TE_{J}, from said measured electric current values I, and from a predetermined temperature distribution T₀;
E) calculating, by means of a further numerical finite element method, a respective electric field distribution Ee_{JX}, Ee_{JY} . . . E_{JL} for each further computational domain DE_{J}, wherein each value of electric field of an electric field distribution is associated with a respective finite element e_{JX}, e_{JY} . . . e_{JL} of said further computational domain DE_{J}, each electric field distribution being calculated by solving:
   Gauss's law for an electric field E in transient conditions, applied to each finite element e_{JY} falling into the dielectric material layer 13,
   the law of continuity of electric current in stationary conditions applied to each finite element e_{JL} which falls in the first semiconductive material layer 12 or in the second semiconductive material layer 14 and which does not contact one or more finite elements e_{JL} which fall into the dielectric material layer 13,
   Schottky's law referred to an injection of electric charges in correspondence of a contact line between different materials, applied to each finite element e_{JX} which falls into the first semiconductive material layer 12 or in the second semiconductive material layer 14 and contacts one or more finite elements e_{JY} which fall into the dielectric material layer 13 (the expression “contact line” or “interface” means the portion of a contact surface between different materials on the section of the electric cable 1 inside the respective area Sⱼ),
   the relationship between electric field E and said voltage V, starting from boundary conditions applied to said first closed line 120 and to said second closed line 140 of the respective further computational domain DE_{J}, in which said boundary conditions depend on said voltage value V and on a predetermined electric charge density distribution ρ₀.

With particular reference to step A, one or more areas Sⱼ are identified along said electric cable 1.

Each area Sⱼ is arranged on a respective plane Pⱼ which is transverse to the longitudinal axis A of the electric cable 1 and has a geometric shape delimited by a closed reference line.

In the embodiment being disclosed, as shown in FIG. 1, a plurality of areas S are identified along said electric cable 1 and each area Sⱼ is external to electric cable 1 and arranged around the electric cable itself, on a respective plane Pⱼ.

In particular, FIG. 1 shows a plurality of areas S₁, S₂, . . . S_{N}, each of which is arranged on a respective plane P₁, P₂, . . . P_{N}.

However, each area Sⱼ can be within said electric cable 1, without departing from the scope of the invention.

The step A can be performed by a processing unit (which can comprise or be constituted of a microcontroller), not shown.

In the embodiment being disclosed, said processing unit is arranged inside a computer C.

With particular reference to step B, reference is made to two computational domains:
a respective computational domain DT_{J} associated with to each area Sⱼ, and
a respective further computational domain DE_{J} associated to a further area which is a portion of said area Sⱼ and is arranged inside said electric cable 1, between said first semiconductive material layer 12 and said second semiconductive material layer 14.

FIGS. 2A, 2B and 2C show a respective computational domain DT₁, DT₂, . . . DT_{N} associated with a respective area S₁, S₂, . . . S_{N}.

FIGS. 3A, 3B and 3C show a respective further computational domain DE₁, DE₂, . . . DE_{N} associated with a respective further area which is a portion of a respective area S₁, S₂, . . . S_{N}.

Each further computational domain DE₁, DE₂, . . . DE_{N} is included in a respective computational domain DT₁, DT₂, . . . DT_{N}.

As said, said further area is included between a first closed line 120, which is a first contact line 120 between the conductor 11 and said first semiconductive material layer 12, and a second closed line 140 which is a second contact line between said second semiconductive material layer 14 and said shield 15.

FIGS. 3A, 3B and 3C show for each further computational domain DE₁, DE₂, . . . DE_{N} the respective first closed line 120 and the second closed line 140.

In particular, each computational domain DT_{J} is discretized through a respective set of finite elements e_{J1}, e_{J2} . . . e_{JM} and each set of finite elements forms a respective grid GT_{J}.

Furthermore, the finite elements e_{J1}, e_{J2} . . . e_{JM} are arranged in such a way as to divide the computational domain DT_{J} in a plurality of slices, each of which is arranged along a predetermined radial direction of the section of the electric cable 1 in said respective area Sⱼ.

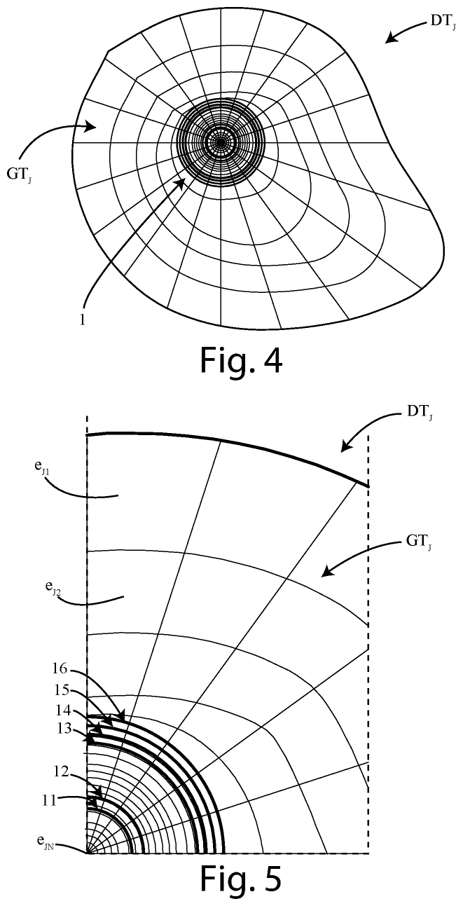

FIG. 4 shows a grid GT_{J} for a general computational domain DT_{J} associated with a general area Sⱼ.

FIG. 5 shows an enlargement of a detail of said grid GT_{J}.

Furthermore, each further computational domain DE_{J} is discretized through a respective further set of finite elements and each further set of finite elements forms a respective further grid GE_{J}.

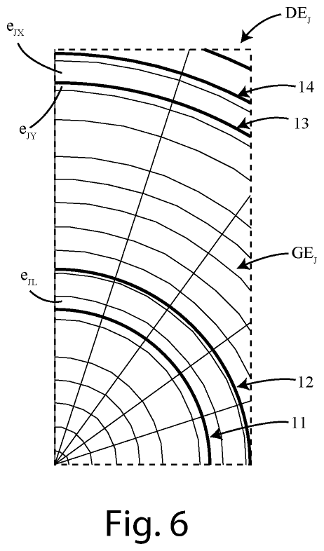

FIG. 6 shows an enlargement of a detail of said further grid GE_{J}. In the embodiment being disclosed, each further set of finite elements is a sub-set of finite elements e_{JX}, e_{JY} . . . e_{JL} of a respective set of finite elements e_{J1}, e_{J2} . . . e_{JM}.

Therefore, the further grid GE_{J} is a portion of the grid GT_{J}.

Step B can be performed by said processing unit.

With particular reference to step C, in the embodiment being disclosed, a respective value of temperature TE_{J} at each area Sⱼ is measured through said temperature measuring means TS_{J}, a value of voltage V between said conductor 11 and said shield 15 is measured through said voltage measuring device 18, and a value of electrical current I flowing along the longitudinal axis A of the conductor 11 is measured through said electric current measuring device 19.

Said temperature measuring means TS_{J} comprise a plurality of temperature sensors for measuring a temperature at a respective area Sⱼ.

In the embodiment being disclosed, said temperature sensors are indicated with the reference TS₁, TS₂, . . . TS_{N} and are arranged on a respective portion of said outer layer 16 of said electric cable 1.

However, said temperature sensors can be arranged inside said electrical cable 1 or at a predetermined distance from said outer layer 16, without departing from the scope of the invention.

In an alternative, not shown in Figures, said temperature measuring means can be comprise a distributed temperature sensor with a longitudinal resolution to measure a temperature at each area Sⱼ.

Said distributed temperature sensor can be arranged inside said electric cable 1 or on said outer layer 16 of said electric cable 1 or at a predetermined distance from said outer layer 16.

With reference to the voltage measuring device 18, in the embodiment being disclosed, said voltage measuring means is a voltmeter.

With reference to the electric current measuring device 19, in the embodiment being disclosed, said electric current measuring device 19 is an ammeter

In an alternative, the value of voltage can be a predetermined voltage value (i.e. a constant value) which is not measured by any voltage measuring device, but is acquired by a processing unit, described below, configured to acquire said predetermined value that can be established by a user.

Also the value of electric current value can be a predetermined electric current value which is not measured by any electric current measuring device, but is acquired by said processing unit configured to acquire said predetermined electric current value which can be established by a user.

However, the measurement of the voltage value and the electric current value is advantageous to correctly calculate the electric field when there are variations in voltage or variations in electric current.

With reference to step D, a respective temperature distribution Te_{J1}, Te_{J2} . . . Te_{JM} for each computational domain DT_{J} is calculated by means of a numerical finite element method.

In particular, the distribution temperature Te_{J1}, Te_{J2} . . . Te_{JM} was calculated assuming that the temperature values vary along a radial direction of the electric cable 1 and along a tangential direction.

In this way, it is possible to take into account the environment in which said electric cable 1 is installed, for example underground, in which the heat exchange between the electric cable 1 and the surrounding environment is different for different portions of each section of the electric cable 1 within a respective area Sⱼ.

The calculation of each temperature distribution is performed by said processing unit.

Said processing unit is connected to each of said temperature TS₁, TS₂, . . . TS_{N} and configured to acquire a respective temperature value TE₁, TE₂, . . . TE_{N} measured by each said temperature sensors.

Furthermore, said processing unit is connected to said electric current measuring device 19 and configured for acquiring an electric current value I from said electric current measuring device 19.

Each temperature value of a respective temperature distribution Te_{J1}, Te_{J2} . . . Te_{JM} is associated with a respective finite element e_{J1}, e_{J2} . . . e_{JM} of a respective computational domain DT_{J}.

Each temperature distribution is calculated by solving the Fourier's law for conducting heat in transient conditions, starting from said temperature values TE_{J} (measured through said temperature measuring means TS_{J}), said measured electric current value I, a predetermined temperature distribution T₀.

Said predetermined temperature distribution T₀ can be stored by the processing unit in storage means (such as a memory), not shown, and said processing unit can be connected to said storage means.

In the embodiment being disclosed, said processing unit comprises said storage means.

In particular, the Fourier's law is expressed in discrete form and is solved with a spatial discretization which is represented by the finite elements of the computational domain DT_{J}, mentioned above, and a temporal discretization.

This temporal discretization has a predetermined time step Δt.

This predetermined time step Δt can be of the order of seconds.

In the embodiment being disclosed, said predetermined time step Δt is constant and equal to 10s.

Furthermore, in an initial time instant t₀, when a quantity of direct electric current begins to flow along the longitudinal axis A of the conductor 11, it is assumed that the predetermined temperature distribution T₀ is constant and equal to the ambient temperature.

With particular reference to step E, a respective electric field distribution Ee_{JX}, Ee_{JY} . . . E_{JL} for each further computational domain DE_{J} is calculated by means a further numerical finite element method.

Each electric field value of an electric field distribution is associated with a respective finite element e_{JX}, e_{JY} . . . e_{JL} of said further computational domain DE_{J}.

Each electric field distribution is calculated by solving:
Gauss's law for an electric field E in transient conditions, applied to each finite element e_{JY} falling into the dielectric material layer 13,
the law of continuity of electric current in stationary conditions applied to each finite element e_{JL} which falls in the first semiconductive material layer 12 or in the second semiconductive material layer 14 and which does not contact one or more finite elements e_{JL} which fall into the dielectric material layer 13,
Schottky's law referred to an injection of electric charges in correspondence of a contact line between different materials, applied to each finite element e_{JX} which falls into the first semiconductive material layer 12 or in the second semiconductive material layer 14 and contacts one or more finite elements e_{JY} which fall into the dielectric material layer 13,
the relationship between electric field E and said voltage V.

The boundary conditions are applied to said first closed line 120 and to said second closed line 140 of the respective further computational domain DE_{J} and depend on said voltage value V measured between said conductor 11 and said shield 15 and on a predetermined electric charge density distribution ρ₀.

In particular, in said initial time instant to, when a quantity of direct electric current begins to flow along the longitudinal axis A of the conductor 11, it is assumed that the predetermined electric charge density distribution ρ₀ is constant and equal to zero.

Gauss's law for an electric field E in transient conditions is expressed in discrete form and is solved with a spatial discretization that is represented by the finite elements of the further computation domain DE_{J}, mentioned above, and a temporal discretization.

Said predetermined time step Δt was also used for this time discretization.

In particular, this temporal discretization can be the same as that used to solve said Fourier's law in transitory conditions.

The law of continuity of electric current in stationary conditions is expressed in discrete form and is solved with a spatial discretization that is represented by the finite elements of the further computation domain DE_{J}, mentioned above.

Schottky's law referred to an injection of electric charges depends on the temperature value, the electric field value, the materials and factors relating to the contact lines or interfaces between materials.

Since the temperature and the electric field associated with the elements belonging to the first semiconductive material layer 12 or to the second semiconductive material layer 14 vary over time and are calculated in real time using the aforementioned method, the injection of electrical charges also varies over time.

Schottky's law can be expressed by the following formula:

$${J}_{Schottky} = {A}_{e l} {T}^{2} \cdot exp ( \frac{- q \cdot {φ}_{e l}}{{k}_{b} \cdot T} ) \cdot exp ( \frac{- q}{{k}_{b} \cdot T} \sqrt{\frac{- q \cdot {E}_{m}}{4 π ε}} ) + {A}_{l a c} {T}^{2} \cdot exp ( \frac{- q \cdot {φ}_{l a c}}{{k}_{b} \cdot T} ) \cdot exp ( \frac{- q}{{k}_{b} \cdot T} \sqrt{\frac{- q \cdot {E}_{m}}{4 π ε}} )$$

where:
Aₑₗ e A_{lac} are respective constants, each of which depends on the materials and the injected electrical charges, in particular:
   Aₑₗ is a first constant dependent on the materials and on the fact that the injected electric charges are electrons, i.e. negative electrical charges;
   A_{lac} è una costante dipendente dai materiali e dal fatto che le cariche elettriche iniettate sono lacune, i.e. cariche elettriche positive; is a constant dependent on the materials and on the fact that the injected electrical charges are electron holes, i.e. positive electric charges;
T is the temperature of the element in which Schottky's law is applied;
q is the elementary electric charge (which is a known constant);
φₑₗ is the potential barrier for the injection of electrons;
φ_{lac} is the potential barrier for the injection of electron holes;
k_{b} is Boltzman's constant (which is a known constant);
ε is the permittivity of the material of the element in which Schottky's law is applied;
Eₘ è is the electric field of the element where Schottky's law is applied.

The parameters φₑₗ and φ_{lac} are parameters that depend on the injected electrical charges (i.e. if the injected electrical charges are electrons or electron holes), on the materials and on one or more factors concerning one or more contact lines or interfaces between different materials, such as material roughness, protrusions of materials, presence of impurities, presence of gaps between materials due to a non-perfect adhesion between the materials (for example due to a detachment of the materials), etc.

The transient conditions for Gauss's law for an electric field E and the stationary conditions for the law of continuity of electric current allow to calculate the electric field distribution Ee_{JX}, Ee_{JY} . . . E_{JL} with significantly reduced calculation times, substantially in real time, compared to known finite element methods used for the calculation of the electric field.

Furthermore, the electric field distribution Ee_{JX}, Ee_{JY} . . . E_{JL} can be calculated assuming that the electric field values vary along a radial direction of the electric cable 1 and along a tangential direction.

Alternatively, the electric field distribution Ee_{JX}, Ee_{JY} . . . E_{JL} can be calculated can be calculated only along a radial direction, assuming that the electric field values vary only along the radial direction of the electric cable 1 and not along the tangential direction, as explained below.

The calculation of each electric field distribution Ee_{JX}, Ee_{JY} . . . E_{JL} is performed by said processing unit.

Said processing unit is connected to said voltage measuring device 18 and configured to acquire a voltage value V from said voltage measuring device 18.

Said predetermined electric charge density distribution ρ₀ can be stored by said processing unit in said storage means.

The method may further comprise the following steps which are performed for each area Sⱼ periodically at predetermined time intervals Δt (in which each predetermined time interval coincides with the predetermined time step mentioned above):
F) calculating an electrical conductivity distribution σe_{JX}, σe_{JY} . . . σe_{JL} for each finite element e_{JX}, e_{JY} . . . e_{JL} of each further computational domain DE_{J}, starting from said calculated temperature distribution Te_{J1}, Te_{J2} . . . Te_{JM} and from said calculated electric field distribution Ee_{JX}, Ee_{JY} . . . E_{JL};
G) calculating an electric current density distribution Je_{JX}, Je_{JY} . . . J_{JL} for each finite element e_{JX}, e_{JY} . . . e_{JL} of each further computational domain DE_{J} through the Ohm's law;
H) calculating a respective value of electric charge density ρe_{JX}, ρe_{JY} . . . ρe_{JL} for each finite element e_{JX}, e_{JY} . . . e_{JL} of each further computational domain DE_{J} by solving:
   the law of continuity of electric current in transient conditions, wherein said law of continuity of electric is applied to each finite element e_{JY} of each further computational domain DE_{J} which falls within the dielectric material layer 13, and
   Gauss's law for an electric field E in stationary conditions, wherein said Gauss's law is applied to each finite element e_{JX}, e_{JL} of each further computational domain DE_{J} which falls in the first semiconductive material layer 12 or in the second semiconductive material layer 14;
I) updating said predetermined temperature distribution T₀ with the temperature values of said calculated temperature distribution Te_{J1}, Te_{J2} . . . Te_{JM} and updating said predetermined electric charge density distribution ρ₀ with the calculated electric charge density values ρe_{JX}, ρe_{JY} . . . ρe_{JL};
J) repeating the steps from C to E.

With reference to the time interval Δt, said time interval is greater than of the computational time for solving calculations menzioned in steps from C to I.

Preferably, said time interval Δt is three orders of magnitude greater than said computational time.

Furthermore, once the computational time is known to calculate the temperature distribution Te_{J1}, Te_{J2} . . . Te_{JM}, the electric field distribution Ee_{JX}, Ee_{JY} . . . E_{JL}, the electrical conductivity distribution σe_{JX}, σe_{JY} . . . σe_{JL}, the electrical current density distribution Je_{JX}, Je_{JY} . . . Je_{JL}, and the electric charge density ρe_{JX}, ρe_{JY} . . . ρe_{JL}, at a given time instant, steps F to J can be performed after a further time interval Δt′ equal to the difference between said time interval Δt and said computational time, so as to obtain a result in real time every time interval Δt.

With particular reference to step F, an electrical conductivity distribution σe_{JX}, σe_{JY} . . . σe_{JL} was calculated by the processing unit of computer C for each further computational domain DE_{J}, starting from the calculated temperature distribution Te_{J1}, Te_{J2} . . . Te_{JM} and the calculated electric field distribution Ee_{JX}, Ee_{JY} . . . Ee_{JL}.

With particular reference to step G, an electrical current density distribution Je_{JX}, Je_{JY} . . . Je_{JL} was calculated by the processing unit of computer C for each further computational domain DE_{J} using Ohm's law.

In particular, the electrical conductivity distribution σe_{JX}, σe_{JY} . . . σe_{JL}, the electrical current density distribution Je_{JX}, Je_{JY} . . . Je_{JL}, and the electric charge density ρe_{JX}, ρe_{JY} . . . ρe_{JL} can be calculated assuming that the values vary along a radial direction of the electric cable 1 and along a tangential direction.

Alternatively, when said electric field distribution Ee_{JX}, Ee_{JY} . . . E_{JL} is calculated only along said radial direction, also the electric conductivity distribution σe_{JX}, σe_{JY} . . . σe_{JL}, the electric current density distribution Je_{JX}, Je_{JY} . . . Je_{JL}, and the electric charge density ρe_{JX}, ρe_{JY} . . . ρe_{JL} can only be calculated along said radial direction, assuming that they do not vary along the tangential directions. In this way, the computation time is further reduced.

With particular reference to step H, by means of the processing unit of computer C, a respective electric charge density value ρe_{JX}, ρe_{JY} . . . ρe_{JL} has been calculated for each finite element e_{JX}, e_{JY} . . . e_{JL} of each further computational domain DE_{J}, solving the law of continuity of electric current in transient conditions and Gauss's law for an electric field E in stationary conditions.

The transient conditions for the law of continuity of electric current and the stationary conditions for Gauss's law for an electric field E allow to calculate the electric charge density ρe_{JX}, ρe_{JY} . . . ρe_{JL} with significantly reduced computation times, substantially in real time, compared to known finite element methods used for the calculation of the electric charge density.

The law of continuity of electric current in transient conditions and Gauss's law for an electric field E in stationary conditions are expressed in discrete form.

With particular reference to step I, the predetermined temperature distribution T₀ is updated with the temperature values of said calculated temperature distribution Te_{J1}, Te_{J2} . . . T_{JM} and the predetermined electric charge density distribution ρ₀ is updated with the calculated electric charge density ρe_{JX}, ρe_{JY} . . . ρe_{JL}.

The updated values of the predetermined temperature distribution T₀ and the updated values of the predetermined electric charge density distribution ρ₀ can be stored in said storage means.

In light of the above, for each time instant tₖ with k=1.2 . . . Z where Z is a positive integer, excluding the initial time instant t₀ mentioned above, the values of the predetermined temperature distribution T₀ and the values of the predetermined electric charge density distribution ρ₀ are equal respectively to the temperature values Te_{J1}, Te_{J2} . . . T_{JM} and to the electric charge density values ρe_{JX}, ρe_{JY} . . . ρe_{JL} calculated in the previous time instant of time tₖ₋₁ (tₖ−tₖ₋₁=Δt).

With particular to step J, the steps C, D and E are repeated at periodic time intervals Δt.

The method steps described above can be used in addition to other steps to monitor the electrical stress to which the electrical cable 1 is subjected with respect to an electrical stress for which the electrical cable was designed or a predetermined electrical stress.

To this end, said method can further comprise the following steps in addition to the steps A to E or steps A to J:
K) identifying a respective maximum value of electric field E_{MAXJ} in each further computational domain DE_{J};
L) comparing each maximum value of electric field E_{MAXJ} with a predetermined value of electric field E_{REF};
M) if said maximum value of electric field E_{MAXJ} is greater than said predetermined value of electric field E_{REF}, establishing that at least one section of electrical cable 1 at each said area Sⱼ is subjected to an electrical stress greater than an electrical stress for which said electrical cable 1 was designed or to a predetermined electrical stress.

In other words, after having identified for each further computational domain DE_{J} a respective maximum value of electric field E_{MAXJ}, each value of electric field E_{MAXJ} is compared with a predetermined value of electric field E_{REF} which is a threshold value and if one or more maximum values of electric field E_{MAXJ} are greater than said predetermined value of electric field E_{REF}, it means that the section of the electric cable 1 at the respective area Sⱼ is subjected to an electric stress higher than an electric stress for which said electric cable 1 has been designed or to a predetermined electrical stress.

With reference to the finite element method, said finite element method mentioned in step D can solve a respective system of linear equations for each computational domain DT_{J}:

$$A {1}_{j} * {T}_{j} = B {1}_{j}$$

dove
A1ⱼ is a first square matrix with a number of rows and a number of columns equal to the number of finite elements e_{J1}, e_{J2} . . . e_{JM} of said computational domain DT_{J}, and each element of said matrix is a constant numeric coefficient depending on the geometric properties of said computational domain DT_{J} and from the thermophysical properties of at least one material associated with a finite element corresponding to a portion of said electric cable 1,
Tⱼ is a first column vector with a number of elements equal to the number of finite elements e_{J1}, e_{J2} . . . e_{JM} of said computational domain DT_{J} and each element of said first column vector is a value of temperature which is unknown,
B1ⱼ is a further first column vector with a number of elements equal to the number of finite elements e_{J1}, e_{J2} . . . e_{JM} of said computational domain DT_{J} and each element is a numeric value variable over time and depending on the boundary conditions of heat exchange between electric cable 1 and external environment, on the temperature of said predetermined temperature distribution T₀ associated with each finite element e_{J1}, e_{J2} . . . e_{JM} of said computational domain DT_{J}, on a thermal power value calculated on the basis of the measured electric current values I flowing in the conductor 11 and the thermophysical properties of at least one material associated with a finite element corresponding to said portion of said electric cable 1.

Furthermore, step D can comprise the following sub-steps:
D1) calculating a respective numeric value associated with each element of each first vector B1ⱼ on the basis of a value of temperature Te_{J1}, Te_{J2} . . . Te_{JM} associated with each finite element e_{J1}, e_{J2} . . . e_{JM} of said computational domain DT_{J} and with the values of thermal power due to the passage of electric current I in the conductor 11 and losses in the dielectric material layer 13;
D2) multiplying said first vector B1ⱼ by a further first matrix A1ⱼ′, which is the inverse matrix of said first matrix A1, to obtain a respective value of temperature Te_{J1}, Te_{J2} . . . Te_{JM} associated with each finite element e_{J1}, e_{J2} . . . e_{JM} of said computational domain DT_{J};
D3) for each computational domain DT_{J} calculating a difference between a respective value of temperature TE_{J} measured at each area Sⱼ and a respective value of temperature between the calculated values of temperature Te_{J1}, Te_{J2} . . . Te_{JM}, wherein said value of temperature is associated with a respective finite element between the finite elements e_{J1}, e_{J2} . . . e_{JM} of said computational domain DT_{J} at which said temperature value has been measured, to obtain a respective temperature variation value ΔT_{J};
D4) for each finite element e_{J1}, e_{J2} . . . e_{JM} of said computational domain DT_{J} calculating a respective updated value of temperature Te_{J1}, Te_{J2} . . . Te_{JM} by adding a respective value of temperature obtained at sub-step D2 and a respective value of temperature variation ΔT_{J} obtained at sub-step D3.

Furthermore, in addition to or alternatively to the sub-steps from D1 to D4, said step D can comprise the following sub-steps:
D5) calculating a temperature gradient of said temperature distribution Te_{J1}, Te_{J2} . . . Te_{JM} inside a respective section of said electric cable 1 in each area Sⱼ along a plurality of radial directions, wherein each value of temperature gradient is associated with a respective finite element e_{J1}, e_{J2} . . . e_{JM} of a respective computational domain DT_{J}, wherein said finite element is arranged inside said electric cable 1; and
D6) identifying a radial direction of said plurality of radial directions associated with a maximum value of said calculated temperature gradient.

The partition of the computational domain DT_{J} into segments along said predetermined radial directions advantageously allows to calculate said temperature gradient along all the radial directions associated with each segment in a simple manner, without the need for any interpolations.

The radial direction associated with a calculated maximum temperature gradient value can be advantageously used to speed up the calculation of the electric field Ee_{JX}, Ee_{JY} . . . E_{JL} in step E, as already mentioned.

In fact, the electric field distribution Ee_{JX}, Ee_{JY} . . . E_{JL} can only be calculated along said radial direction identified in sub-step D6.

In this way, it is possible to reduce the calculation times, since the electric field Ee_{JX}, Ee_{JY} . . . E_{JL} is calculated only along the radial direction subject to the maximum temperature gradient used as an index to identify the worst situation.

Furthermore, also the electrical conductivity distribution σe_{JX}, σe_{JY} . . . σe_{JL}, the electrical current density distribution Je_{JX}, Je_{JY} . . . Je_{JL}, and the electric charge density ρe_{JX}, ρe_{JY} . . . ρe_{JL} can only be calculated along said radial direction identified in sub-step D6.

This further reduces the computation time for calculating the electric field.

With reference to the further numerical finite element method mentioned in step E, said further numerical finite element method at step E can solve a respective linear equation system for each further computational domain DE_{J}

$$A {2}_{j} * {E}_{j} = B {2}_{j}$$

where
A2ⱼ is a second square matrix with a number of rows and a number of columns equal to a number of finite elements of said further computational domain DE_{J} and each element of said matrix is a constant numeric coefficient depending on the geometric properties of said further computational domain DE_{J} and on the dielectric properties of at least one of a material associated with said portion of said electric cable 1 which falls inside said further computational domain DE_{J},
Eⱼ is a second column vector with a number of elements equal to the number of finite elements e_{JX}, e_{JY} . . . e_{JL} of said further computational domain DE_{J} and each element is a numeric value of electric field Ee_{JX}, Ee_{JY} . . . E_{JL} associated with each finite element e_{JX}, e_{JY} . . . e_{JL} of said further computational domain DE_{J},
B2ⱼ is a further second column vector with a number of elements equal to the number of finite elements e_{JX}, e_{JY} . . . e_{JL} of said further computational domain DE_{J}, wherein each element is a numeric value depending on the boundary conditions of electric field E, on said value of voltage V and on said predetermined electric charge density distribution ρ₀ associated with each finite element e_{JX}, e_{JY} . . . e_{JL} of said further computational domain DE_{J}.

Furthermore, the step E can comprise the following sub-steps
E1) calculating a respective numerical value associated with each element of each second vector B2ⱼ on the basis of an electric charge density value ρ₀ associated with each finite element e_{JX}, e_{JY} . . . e_{JL} of said further computational domain DE_{J} and said measured voltage value V;
E2) multiply said second vector B2ⱼ by a further second matrix A2ⱼ′ which is the inverse matrix of said second matrix A2ⱼ to obtain a respective electric field value Ee_{JX}, Ee_{JY} . . . E_{JL} associated with each finite element e_{JX}, e_{JY} . . . e_{JL} of said further computational domain DE_{J}.

Said method further comprises the following steps for taking into account a thermal conduction along the longitudinal axis A of the conductor 11:
N1) calculating for each area Sⱼ the mean value of temperature T̅_̅{̅c̅j̅}̅ in the conductor 11;
N2) calculating:
a first axial temperature gradient GR1_{J} as a difference between the mean value of temperature T̅_̅{̅c̅j̅}̅ in the conductor 11 at an area Sⱼ and the mean value of temperature T̅_̅{̅c̅j̅-̅1̅}̅ in the conductor 11 at a previous area Sⱼ₋₁ by dividing for a value equal to a first distance d₁ between said area Sⱼ and said previous area Sⱼ₋₁, and a second axial temperature gradient GR2_{J} as a difference between the mean value of temperature T̅_̅{̅c̅j̅+̅1̅}̅ in the conductor 11 at an area Sⱼ₊₁ and the mean value of temperature T̅_̅{̅c̅j̅}̅ in the conductor 11 at a previous area Sⱼ by dividing for a value equal to a second distance d₂ between said area Sⱼ₊₁ and said previous area Sⱼ;
N3) multiplying the result due to the difference between said first axial temperature gradient GR1_{J} and said second axial temperature gradient GR2_{J} for a mean value of thermal conductivity of the conductor 11 for obtaining a respective thermal power flow value Qⱼ for each area Sⱼ;
N4) for each area Sⱼ calculating, according to a method to discretize differential equations, each element of said further first vector B1ⱼ taking into account said thermal power flow value Qⱼ.

In the embodiment being disclosed, said first distance d₁ is equal to said second distance d₂.

Furthermore, the method can further comprise further steps in addition to steps A to M for obtaining a value of waiting time t_{RP} which is the time to wait before the polarity of said voltage V between said conductor 11 and said shield 15 is inverted after that the value of said voltage V has been set equal to zero, without said maximum value of electric field E_{MAXJ} is greater than said predetermined value of electric field E_{REF}:

When a high voltage electric cable for direct electric current is connected to a converter, such as a current source converter, the polarity inversion of said voltage V allows to reverse the direction of the electric current I flowing along the longitudinal axis of the conductor 11.

To this end, said method can comprise the following steps:
O1) associating a value equal to zero with said waiting time t_{RP};
O2) repeating the steps from C to M or from C to N4 for a predetermined number iterations NI considering a predetermined further time interval Δt_{RP}, wherein said value of voltage V and said value of electric current I have been set equal to zero;
O3) for each iteration, adding the value of said predetermined further time interval Δt_{RP} to a respective value of waiting time t_{RP} to obtain a respective updated value of waiting time t_{RP};
O4) repeating the steps from C to M or from C to N4 for a predetermined further number of iterations MI considering said predetermined further time interval Δt_{RP}, wherein said value of voltage V is in absolute value equal to a nominal voltage value and has a sign opposite to the sign of said value of voltage V before the polarity of said voltage V is inverted, and said value of electric current I is equal to zero;
O5) identifying for each area Sⱼ the maximum value of electric field E_{MAXJ} and identify for each iteration of said predetermined further number of iterations MI a respective maximum value of electric field E_{MAXRP} between said maximum values of electric field, wherein said maximum value of electric field E_{MAXRP} is the maximum value of electric field reached after an inversion of polarity of the voltage V between said conductor 11 and said shield 15 with a waiting time equal to the waiting time t_{RP};
O6) repeating the steps from O1 to O5 by progressively increasing said predetermined number of iterations NI until the maximum value of electric field E_{MAXRP} is less than or equal to said predetermined value of electric field E_{REF} and storing the value of waiting time t_{RP} corresponding to said maximum value of electric field E_{MAXRP}.

In general, in use, the conductor 11 is connected to a converter and the shield 15 is connected to ground.

In particular, when the conductor 11 is connected to a current source converter, to prevent the dielectric material layer from being subjected to an electrical stress greater than a predetermined electrical stress (which can be a desired or required stress) or stress for which the electric cable 1 has been designed, an operator can invert the polarity of said voltage V through said converter after having waited a time greater than or equal to t_{RP} after the value of said voltage V has been set equal to zero.

Consequently, the method comprise the step of connecting said conductor 11 to a converter and said shield 15 to ground.

The present invention relates also to system for calculating a electric field inside a dielectric material layer 13 of a high voltage electric cable 1 for direct electric current, disclosed above.

Said system comprises:
temperature measuring means TS_{J};
a processing unit connected to said temperature measuring means TS_{J} and configured to:
   identifying one or more areas Sⱼ, with j=1, 2 . . . N where N is a positive integer, each of which is arranged along said electric cable 1, on a respective plane Pⱼ transverse to the longitudinal axis A of said electric cable 1 and has a geometric shape defined by a closed reference line;
   associating a respective computational domain DT_{J} with each area Sⱼ, as well as associating a respective further computational domain DE_{J} with a further area which is a portion of said area Sⱼ and is arranged inside said electric cable 1, between said first semiconductive material layer 12 and said second semiconductive material layer 14, wherein said further area is included between a first closed line 120 and a second closed line 140, said computational domain DT_{J} is. discretized through a set of finite elements e_{J1}, e_{J2} . . . e_{JM}, said further computational domain DE_{J} is discretized through a further set of finite elements e_{JX}, e_{JY} . . . e_{JL} (in transversal section said first closed line 120 is a first contact line between the conductor 11 and said first semiconductive material layer 120 and said second closed line 140 is a second contact line between said second semiconductive layer 14 and said shield 15;
   acquiring:
a value of temperature TE_{J} at each area Sⱼ through temperature measuring means TS_{J};
a value of voltage V between said conductor 11 and said shield 15,
a value of electric current I flowing along the longitudinal axis A of the conductor 11;
   calculating, by means of a numerical finite element method, a respective temperature distribution Te_{J1}, Te_{J2} . . . Te_{JM} for each computational domain DT_{J}, wherein each value of temperature of a temperature distribution is associated with a respective finite element e_{J1}, e_{J2} . . . e_{JM} of a respective computational domain DT_{J}, each temperature distribution being calculated by solving:
      Fourier's law for conducting heat in transient conditions, starting from said temperature values TE_{J}, from said measured electric current values I, and from a predetermined temperature distribution T₀;
   calculating, by means of a further numerical finite element method, a respective electric field distribution Ee_{JX}, Ee_{JY} . . . E_{JL} for each further computational domain DE_{J}, wherein each value of electric field of an electric field distribution is associated with a respective finite element e_{JX}, e_{JY} . . . e_{JL} of said further computational domain DE_{J}, each electric field distribution being calculated by solving:
      Gauss's law for an electric field E in transient conditions, applied to each finite element e_{JY} falling into the dielectric material layer 13,
      the law of continuity of electric current in stationary conditions applied to each finite element e_{JL} which falls in the first semiconductive material layer 12 or in the second semiconductive material layer 14 and which does not contact one or more finite elements e_{JL} which fall into the dielectric material layer 13,
      Schottky's law referred to an injection of electric charges in correspondence of a contact line between different materials, applied to each finite element e_{JX} which falls into the first semiconductive material layer 12 or in the second semiconductive material layer 14 and contacts one or more finite elements e_{JY} which fall into the dielectric material layer 13,
      the relationship between electric field E and said voltage V, starting from boundary conditions applied to said first closed line 120 and to said second closed line 140 of the respective further computational domain DE_{J}, in which said boundary conditions depend on said voltage value V and on a predetermined electric charge density distribution ρ₀.

In other words, said processing unit is configured to perform the steps from A to E of the method disclosed above.

In particular, in the embodiment being disclosed, said system comprises-a voltage measuring voltage 18 for measuring said voltage value V between said conductor 11 and said shield 15 and said processing unit is connected to said voltage measuring device 18 for acquiring said voltage value V.

However, said voltage value V can be a predetermined voltage value set by a user and said processing unit can be configured to acquire said predetermined voltage value, according to step C of the method described above.

Furthermore, in the embodiment being disclosed, said system comprise an electric current measuring device 19 for measuring said electric current value I flowing along the longitudinal axis of the conductor 11 and said processing unit is connected to said electric current measuring device 19 for acquiring said electric current value I, according to step C of the method described above.

However, said electric current value I can be a predetermined electric current value set by a user and said processing unit can be configured for acquiring said predetermined electric current value.

In particular, said system can comprise storage means (such as a memory) and said processing unit can be connected to said storage means for storing in said storage means said predetermined voltage value and/or said predetermined electric current value, when the voltage value V and the electric current value I are not measured.

With reference to step D of the method, said processing unit can be configured to perform the sub-steps from D1 to D4 and/or from D5 to D6 of said step D.

Furthermore, said processing unit can be configured to perform the steps from F to J of the method disclosed above or to perform in addition or as alternative to said steps from F to J, the steps from I to M of said method.

In particular, said processing unit can be configured to perform the steps from N1 to N4 of the method.

More particularly, said processing unit can be configured to perform the steps from O1 to O6 of the method disclosed above, for obtaining a value of waiting time t_{RP} which is the time to wait before the polarity of said voltage V between said conductor 11 and said shield 15 is inverted after that the value of said voltage V has been set equal to zero, without said maximum value of electric field E_{MAXJ} is greater than said predetermined value of electric field E_{REF}:

Furthermore, said processing unit can be configured to store said predetermined temperature distribution T₀ and said predetermined electric charge density distribution ρ₀, independently of the storage of said predetermined voltage value and/or said predetermined electric current value.

Said processing unit can also be configured to store in said storage means said predetermined electric field value E_{REF} (which is a threshold value) and/or said waiting time t_{RP}.

Said system can comprise displaying means, such a display D of the computer C, for displaying the values of one or more quantities calculated using the method described above and/or the values of one or more quantities derived from said calculated quantities.

By way of example, it is possible to display in numerical form or by charts:
one or more temperature maximum values in the conductor 11 of a respective temperature distribution Te_{J1}, Te_{J2} . . . Te_{JM} calculated for a respective area Sⱼ; and/or
ore or more temperature maximum values on the outer layer 16 of a respective temperature distribution Te_{J1}, Te_{J2} . . . Te_{JM} calculated for a respective area Sⱼ; and/or
one or more difference values indicating the temperature difference between the temperature associated with the first closed line 120 and the temperature associated with the second closed line 140 of a respective temperature distribution Te_{J1}, Te_{J2} . . . Te_{JM} calculated for a respective area Sⱼ; and/or
said electric field distribution Ee_{JX}, Ee_{JY} . . . E_{JL} and said predetermined electric field E_{REF}; and/or
said electric charge density distribution ρe_{JX}, ρe_{JY} . . . ρe_{JL}; and/or
one or more temperature maximum values in the conductor 11 of a respective temperature distribution Te_{J1}, Te_{J2} . . . Te_{JM} calculated along the longitudinal axis A of the electric cable 1; and/or
one or more difference values indicating the temperature difference between the temperature associated with the first closed line 120 and the temperature associated with the second closed line 140 of a respective temperature distribution Te_{J1}, Te_{J2} . . . Te_{JM} calculated along the longitudinal axis A of the electrical cable 1; and/or
one or more electric field maximum values of a respective electric field distribution Ee_{JX}, Ee_{JY} . . . E_{JL} calculated for each area Sⱼ along the longitudinal axis A of the electric cable 1.

Said displaying means can also be used to display:
the position of the area Sⱼ associated with the temperature maximum value in the conductor 11 obtained by said temperature distribution Te_{J1}, Te_{J2} . . . T_{JM} calculated for each area Sⱼ; and/or
the position of the area S associated with the electric field maximum value of said electric field distribution Ee_{JX}, Ee_{JY} . . . E_{JL} calculated for each area Sⱼ.

Furthermore, when the polarity of the voltage V between the conductor 11 and the shield 15 of the electric cable 1 is inverted, said displaying means can display:
the electric field value calculated during step O2; and/or
the chart of the electric charge density distribution ρe_{JX}, ρe_{JY} . . . ρe_{JL} referred to an area Sⱼ which is the area in which the maximum value of the electric field is the maximum between the maximum values of electric field; and/or
the chart of the electric field distribution Ee_{JX}, Ee_{JY} . . . E_{JL} referred to an area Sⱼ which is the area in which the maximum value of electric field is the maximum between the maximum values of electric field and/or said predetermined electric field value E_{REF}.

### Advantages

Advantageously, the method object of the invention allows to calculate, substantially in real time, the electric field within a dielectric material layer of a high voltage electric cable for direct electric current.

A further advantage is given by the fact that this calculation can be performed on any computer, as it requires reduced computational resources.

Furthermore, through the information regarding the electric field and the comparison with a predetermined electric field value, it is possible to monitor the electric stress of said electric cable with respect to the stress for which the electric cable was designed or to a desired stress.

Consequently, it is possible to improve the reliability of the electrical cable and increase the life span of the electrical cable.

The present invention has been described for illustrative, but not limitative purposes, according to its preferred embodiment, but it is to be understood that variations and/or modifications can be carried out by a skilled in the art, without departing from the scope thereof, as defined according to enclosed claims.

1. A method for calculating an electric field inside a dielectric material layer of a high voltage electric cable for direct electric current, wherein said electric cable is of the type comprising from the inside towards the outside a conductor having a longitudinal axis, a first semiconductive material layer, said dielectric material layer, a second semiconductive material layer, a metallic material layer called shield, said method comprising:
A) identifying one or more areas Sⱼ, with j=1, 2 . . . N where N is a positive integer, each of which is arranged along said electric cable, on a respective plane Pⱼ transverse to the longitudinal axis of said electric cable (and has a geometric shape defined by a closed reference line;
B) associating a respective computational domain DT_{J} with each area Sⱼ, as well as associating a respective further computational domain DE_{J} with a further area which is a portion of said area Sⱼ and is arranged inside said electric cable, between said first semiconductive material layer and said second semiconductive material layer, wherein said further area is included between a first closed line and a second closed line, said computational domain DT_{J} being discretized through a set of finite elements e_{J1}, e_{J2} . . . e_{JM}, said further computational domain DE_{J} being discretized through a further set of finite elements e_{JX}, e_{JY} . . . e_{JL}, in transversal section said first closed line being a first contact line between the conductor and said first semiconductive material layer and said second closed line being a second contact line between said second semiconductive layer and said shield;
C) acquiring:
a value of temperature TE_{J} at each area Sⱼ through a temperature measuring device (TS_{J});
a value of voltage V between said conductor and said shield, wherein said value of voltage V is obtained through a voltage measuring device or is a predetermined value of voltage;
a value of electric current I flowing along the longitudinal axis of the conductor, wherein said value of electric current I is obtained through an electric current measuring device or is a predetermined value of electric current;
D) calculating, by a numerical finite element method, a respective temperature distribution Te_{J1}, Te_{J2} . . . Te_{JM} for each computational domain DT_{J}, wherein each value of temperature of a temperature distribution is associated with a respective finite element e_{J1}, e_{J2} . . . e_{JM} of a respective computational domain DT_{J}, each temperature distribution being calculated by solving:
Fourier's law for conducting heat in transient conditions,
starting from said temperature values TE_{J}, from said measured electric current values I, and from a predetermined temperature distribution T₀;
E) calculating, by a further numerical finite element method, a respective electric field distribution Ee_{JX}, Ee_{JY} . . . E_{JL} for each further computational domain DE_{J}, wherein each value of electric field of an electric field distribution is associated with a respective finite element e_{JX}, e_{JY} . . . e_{JL} of said further computational domain DE_{J}, each electric field distribution being calculated by solving:
Gauss's law for an electric field E in transient conditions, applied to each finite element e_{JY} falling into the dielectric material layer,
the law of continuity of electric current in stationary conditions applied to each finite element e_{JL} which falls in the first semiconductive material layer or in the second semiconductive material layer and which does not contact one or more finite elements e_{JL} which fall into the dielectric material layer,
Schottky's law referred to an injection of electric charges in correspondence of a contact line between different materials, applied to each finite element e_{JX} which falls into the first semiconductive material layer or in the second semiconductive material layer and contacts one or more finite elements e_{JY} which fall into the dielectric material layer,
the relationship between electric field E and said voltage V,
starting from boundary conditions applied to said first closed line and to said second closed line of the respective further computational domain D_{EJ}, in which said boundary conditions depend on said voltage value V and on a predetermined electric charge density distribution ρ₀.

2. The method according to claim 1, wherein said method comprises the followings which are performed periodically at predetermined time intervals Δt for each area Sⱼ:
F) calculating an electrical conductivity distribution σe_{JX}, σe_{JY} . . . σe_{JL} for each finite element e_{JX}, e_{JX} . . . e_{JL} of each further computational domain DE_{J}, starting from said calculated temperature distribution Te_{J1}, Te_{J2} . . . Te_{JM} and from said calculated electric field distribution Ee_{JX}, Ee_{JY} . . . E_{JL};
G) calculating an electric current density distribution Je_{JX}, Je_{JY} . . . J_{JL} for each finite element e_{JX}, e_{JY} . . . e_{JL} of each further computational domain DE_{J} through the Ohm's law;
H) calculating a respective value of electric charge density ρe_{JX}, ρe_{JY} . . . ρe_{JL} for each finite element e_{JX}, e_{JY} . . . e_{JL} of each further computational domain DE_{J} by solving:
the law of continuity of electric current in transient conditions, applied to each finite element e_{JY} of each further computational domain DE_{J} which falls within the dielectric material layer, and
Gauss's law for an electric field E in stationary conditions, applied to each finite element e_{JX}, e_{JL} of each further computational domain DE_{J} which falls in the first semiconductive material layer or in the second semiconductive material layer;
I. updating said predetermined temperature distribution T₀ with the temperature values of said calculated temperature distribution Te_{J1}, Te_{J2} . . . Te_{JM} and updating said predetermined electric charge density distribution ρ₀ with the calculated electric charge density values ρe_{JX}, ρe_{JY} . . . ρe_{JL};
J) repeating said C to E.

3. The method according to claim 1, wherein said method comprises:
K) identifying a respective maximum value of electric field E_{MAXJ} in each further computational domain DE_{J};
L) comparing each maximum value of electric field E_{MAXJ} with a predetermined value of electric field E_{REF};
M) if said maximum value of electric field E_{MAXJ} is greater than said predetermined value of electric field E_{REF}, establishing that at least one section of electrical cable at each said area Sⱼ is subjected to an electrical stress greater than an electrical stress for which said electrical cable was designed or to a predetermined electrical stress.

4. The method according to claim 1, wherein
said finite element method at said D solves a respective system of linear equations for each computational domain DT_{J}:
$$A {1}_{j} * {T}_{j} = B {1}_{j}$$
where
A1ⱼ is a first square matrix with a number of rows and a number of columns equal to the number of finite elements e_{J1}, e_{J2} . . . e_{JM} of said computational domain DT_{J}, and each element of said matrix is a constant numeric coefficient depending on the geometric properties of said computational domain DT_{J} and from the thermophysical properties of at least one material associated with a finite element corresponding to a portion of said electric cable,
Tⱼ is a first column vector with a number of elements equal to the number of finite elements e_{J1}, e_{J2} . . . e_{JM} of said computational domain DT_{J} and each element of said first column vector is a value of temperature which is unknown,
B1ⱼ is a further first column vector with a number of elements equal to the number of finite elements e_{J1}, e_{J2} . . . e_{JM} of said computational domain DT_{J} and each element is a numeric value variable over time and depending on the boundary conditions of heat exchange between electric cable and external environment, on the temperature of said predetermined temperature distribution T₀ associated with each finite element e_{J1}, e_{J2} . . . e_{JM} of said computational domain DT_{J}, on a thermal power value calculated on the basis of the measured electric current values I flowing in the conductor and the thermophysical properties of at least one material associated with a finite element corresponding to said portion of said electric cable,
wherein
said D comprises:
D1) calculating a respective numeric value associated with each element of each first vector B1ⱼ on the basis of a value of temperature Te_{J1}, Te_{J2} . . . Te_{JM} associated with each finite element e_{J1}, e_{J2} . . . e_{JM} of said computational domain DT_{J} and with the values of thermal power due to the passage of electric current I in the conductor and losses in the dielectric material layer;
D2) multiplying said first vector B1ⱼ by a further first matrix A1ⱼ′, which is the inverse matrix of said first matrix A1, to obtain a respective value of temperature Te_{J1}, Te_{J2} . . . Te_{JM} associated with each finite element e_{J1}, e_{J2} . . . e_{JM} of said computational domain DT_{J};
D3) for each computational domain DT_{J} calculating a difference between a respective value of temperature TE_{J} measured at each area S and a respective value of temperature between the calculated values of temperature Te_{J1}, Te_{J2} . . . Te_{JM}, wherein said value of temperature is associated with a respective finite element between the finite elements e_{J1}, e_{J2} . . . e_{JM} of said computational domain DT_{J} at which said temperature value has been measured, to obtain a respective temperature variation value ΔT_{J};
D4) for each finite element e_{J1}, e_{J2} . . . e_{JM} of said computational domain DT_{J} calculating a respective updated value of temperature Te_{J1}, Te_{J2} . . . Te_{JM} by adding a respective value of temperature obtained at said D2 and a respective value of temperature variation ΔT_{J} obtained at said D3.

5. The method according to claim 1, wherein said D comprises:
D5) calculating a temperature gradient of said temperature distribution Te_{J1}, Te_{J2} . . . Te_{JM} inside a respective section of said electric cable in each area Sⱼ along a plurality of radial directions, wherein each value of temperature gradient is associated with a respective finite element e_{J1}, e_{J2} . . . e_{JM} of a respective computational domain DT_{J}, wherein said finite element is arranged inside said electric cable; and
D6) identifying a radial direction of said plurality of radial directions associated with a maximum value of said calculated temperature gradient, and wherein
said electric field distribution Ee_{JX}, Ee_{JY} . . . E_{JL} at said step-E is calculated only along said radial direction identified at said D6, assuming that the respective values of electric field vary only along said radial direction of said electric cable.

6. The method according to claim 1, wherein the electrical conductivity distribution σe_{JX}, σe_{JY} . . . σe_{JL} at said F, the electric current density distribution Je_{JX}, Je_{JY} . . . J_{JL} at said G and each value of electric charge density ρe_{JX}, ρe_{JY} . . . ρe_{JL} at said H are calculated along said radial direction of said electric cable identified at said D6.

7. The method according to claim 1, wherein said method further comprises the followings for taking into account a thermal conduction along the longitudinal axis of the conductor:
N1) calculating for each area Sⱼ the mean value of temperature T̅_̅{̅c̅j̅}̅ in the conductor;
N2) calculating:
a first axial temperature gradient GR1_{J} as a difference between the mean value of temperature T̅_̅{̅c̅j̅}̅ in the conductor at an area Sⱼ and the mean value of temperature T̅_̅{̅c̅j̅-̅1̅}̅ in the conductor at a previous area Sⱼ₋₁ by dividing for a value equal to a first distance d₁ between said area Sⱼ and said previous area Sⱼ₋₁, and
a second axial temperature gradient GR2_{J} as a difference between the mean value of temperature T̅_̅{̅c̅j̅+̅1̅}̅ in the conductor at an area Sⱼ₊₁ and the mean value of temperature T̅_̅{̅c̅j̅}̅ in the conductor at a previous area S by dividing for a value equal to a second distance d₂ between said area Sⱼ₊₁ and said previous area Sⱼ;
N3) multiplying the result due to the difference between said first axial temperature gradient GR1_{J} and said second axial temperature gradient GR2_{J} for a mean value of thermal conductivity of the conductor for obtaining a respective thermal power flow value Qⱼ for each area Sⱼ;
N4) for each area Sⱼ calculating, according to a method to discretize differential equations, each element of said further first vector B1ⱼ taking into account said thermal power flow value Qⱼ.

8. The method according to claim 7, wherein said first distance d₁ is equal to said second distance d₂.

9. The method according to claim 1, wherein said further numerical finite element method at said E solves a respective linear equation system for each further computational domain DE_{J}:
$$A {2}_{j} * {E}_{j} = B {2}_{j}$$
where
A2ⱼ is a second square matrix with a number of rows and a number of columns equal to a number of finite elements of said further computational domain DE_{J} and each element of said matrix is a constant numeric coefficient and depends on the geometric properties of said further computational domain DE_{J} and on the dielectric properties of at least one of a material associated with said portion of said electric cable which falls inside said further computational domain DE_{J},
Eⱼ is a second column vector with a number of elements equal to the number of finite elements e_{JX}, e_{JY} . . . e_{JL} of said further computational domain DE_{J} and each element is a numeric value of electric field Ee_{JX}, Ee_{JY} . . . E_{JL} associated with each finite element e_{JX}, e_{JY} . . . e_{JL} of said further computational domain DE_{J},
B2ⱼ is a further second column vector with a number of elements equal to the number of finite elements e_{JX}, e_{JY} . . . e_{JL} of said further computational domain DE_{J}, wherein each element is a numeric value depending on the boundary conditions of electric field E, on said value of voltage V and on said predetermined electric charge density distribution ρ₀ associated with each finite element e_{JX}, e_{JY} . . . e_{JL} of said further computational domain DE_{J}.

10. The method according to claim 2, wherein said method further comprises the followings to obtain a value of waiting time t_{RP} which is the time to wait before the polarity of said voltage V between said conductor and said shield is inverted after that the value of said voltage V has been set equal to zero, without said maximum value of electric field E_{MAXJ} is greater than said predetermined value of electric field E_{REF}:
O1. associating a value equal to zero with said waiting time t_{RP};
O2. repeating said C to M or said C to N4 for a predetermined number iterations NI considering a predetermined further time interval Δt_{RP}, wherein said value of voltage V and said value of electric current I have been set equal to zero;
O3. for each iteration, adding the value of said predetermined further time interval Δt_{RP} to a respective value of waiting time t_{RP} to obtain a respective updated value of waiting time t_{RP};
O4. repeating said C to M or C to N4 for a predetermined further number of iterations MI considering said predetermined further time interval Δt_{RP}, wherein said value of voltage V is in absolute value equal to a nominal voltage value and has a sign opposite to the sign of said value of voltage V before the polarity of said voltage V is inverted, and said value of electric current I is equal to zero;
O5. identifying for each area S; the maximum value of electric field E_{MAXJ} and identify for each iteration of said predetermined further number of iterations MI a respective maximum value of electric field E_{MAXRP} between said maximum values of electric field, wherein said maximum value of electric field E_{MAXRP} is the maximum value of electric field reached after an inversion of polarity of the voltage V between said conductor and said shield with a waiting time equal to the waiting time t_{RP};
O6. repeating said O1 to O5 by progressively increasing said predetermined number of iterations NI until the maximum value of electric field E_{MAXRP} is less than or equal to said predetermined value of electric field E_{REF} and storing the value of waiting time t_{RP} corresponding to said maximum value of electric field E_{MAXRP}.

11. The method according to claim 1, wherein said area Sⱼ is outside said electric cable.

12. The method according to claim 1, wherein said area Sⱼ is inside said electric cable.

13. The method according to claim 1, wherein
said electric cable comprises an external layer, and
wherein
said temperature measuring (TS_{J}) comprises a plurality of temperature sensors (TS_{1J}) for measuring a temperature at a respective area Sⱼ and said temperature sensors are arranged inside said electric cable or a respective portion of said external layer or at a predetermined distance from said external layer.

14. The method according to claim 1, wherein
said electric cable comprises an external layer, and
wherein
said temperature measuring device comprises a temperature distributed sensor with a longitudinal resolution for measuring a temperature at each area Sⱼ and said temperature distributed sensor is arranged inside said electric cable or on said external layer or at a predetermined distance from said external layer.

15. A system for calculating an electric field inside a dielectric material layer of a high voltage electric cable for direct electric current, wherein said electric cable is of the type comprising from the inside towards the external a conductor having a longitudinal axis, a first semiconductive material layer, said dielectric material layer, a second semiconductive material layer, a metallic material layer called shield, said system comprising:
temperature measuring device (TS_{J}) for measuring a value of temperature at one or more areas Sⱼ, with j=1, 2 . . . N where N is a positive integer, each of which is arranged along said electric cable on a respective plane Pⱼ transverse to the longitudinal axis of said electric cable and has a geometric shape defined from a closed reference line;
a processor connected to said temperature measuring device (TS_{J}) and configured to perform the method according to claim 1.

16. The system according to claim 15, wherein said system comprises:
a voltage measuring device for measuring a value of voltage V between said conductor and said shield;
an electric current measuring device or measuring a value of electric current I flowing along the longitudinal axis of the conductor;
wherein
said processor is connected to said voltage measuring device and to said electric current measuring device and configured to acquire a value of voltage V through said voltage measuring device and said value of electric current I through said electric current measuring device.

17. The system according to claim 15, wherein, said system comprises a storage and said processor is connected to said storage is configured to store a predetermined value of voltage and/or a predetermined value of electric current and to acquire said predetermined value of voltage and/or said predetermined value of electric current from said storage.

18. The system according to claim 15, wherein, said system comprises a storage and said processor is connected to said storage and configured to store said predetermined temperature distribution T₀ and said predetermined electric charge density distribution ρ₀.
